(19) United States
(12) Patent Application Publication
(10) Pub. No.: US 2006/0217025 A1
(43) Pub. Date: Sep. 28, 2006

(54) Method for enhancing homogeneity of carbon nanotube electron emission source made by electrophoresis deposition

(75) Inventors: Chun-Yen Hsiao, Taoyuan County (TW); Shie-Heng Lee, Taoyuan County (TW); Yu-An Li, Taoyuan County (TW); Jin-Lung Tsai, Taoyuan County (TW); Kuei-Wen Cheng, Taoyuan County (TW)

Correspondence Address: HDSL, 4331 STEVENS BATTLE LANE, FAIRFAX, VA, 22033, US

(73) Assignee: Teco Nanotech Co., Ltd.

(21) Appl. No.: 11/090,221

(22) Filed: Mar. 28, 2005

(51) Int. Cl. H01J 9/00; H01J 9/20

(52) U.S. Cl. 445/50; 445/49; 445/51; 445/58

(57) ABSTRACT

A method for enhancing the homogeneity of carbon nanotube electron emission source which is manufactured using electrophoresis deposition. The method includes the following steps. First, a semi-manufactured cathode structure is prepared. Then, the cathode structure and the metallic plate are connected to the electrophoresis electrodes. After that, the side of the cathode structure to be electrophoresis deposited is kept a fixed distance in parallel with the metallic plate. Then, the electrophoresis deposition is performed to the semi-manufactured cathode structure by placing the combination into the solution of the electrophoresis tank. Later, an electric field is formed from a direct current pulse voltage of a power supply. In this manner, the carbon nanotubes are deposited on the cathode electrode to form the electron emission source. After the deposition process of the cathode structure is completed, the combination is baked with a low temperature so as to remove the residual water solution on the cathode structure. Meanwhile, the indium chloride charger and the electrolyte hydroxide ions react to form indium hydroxide. Next, a sintering process is performed for re-oxidating the indium hydroxide on the cathode electrode layer back to indium oxide. Consequently, the electron conductivity of the carbon nanotubes and the cathode electron layer is enhanced.

### BACKGROUND OF THE INVENTION

The present invention relates generally to a method for enhancing the homogeneity of carbon nanotube electron emission source that is manufactured by electrophoresis deposition. More particularly, the present invention relates to a method that employs certain electrophoresis condition for the electrophoresis carbon nanotube water solution to improve the distribution property of carbon nanotubes in the electrophoresis water solution during the arch discharge process. The method is also to enhance the homogeneity of electrophoresis on the cathode structure, thereby achieving a better electrophoresis deposition effect.

Conventional triode field emission display includes an anode structure and a cathode structure. There is a spacer disposed between the anode structure and the cathode structure, thereby providing a space and a support for the vacuum region between the anode structure and the cathode structure. The anode structure includes an anode substrate, an anode conducting layer, and a phosphorus layer, while the cathode structure includes a cathode substrate, a cathode conducting layer, an electron emission layer, a dielectric layer and a gate layer. The gate layer is provided a voltage difference to induce the emission of electrons from the electron emission layer. The conducting layer of the cathode structure provides a high voltage to accelerate the electron beam, such that the electron beam can have enough kinetic energy to impinge and excite the phosphorous layer on the anode structure, thereby emitting light. Accordingly, in order to maintain the movement of electrons in the field emission display, a vacuum apparatus is required to keep the vacuum degree of the display being below 10⁻⁵ torr. Therefore, the electrons can have appropriate mean free paths. Meanwhile, the pollution and toxication of the electron emission source and the phosphorous layer should be prevented from happening. Furthermore, in order for the electrons to accumulate enough energy to impinge the phosphorous powder, a space is required between the two substrates. Consequently, the electrons can be accelerated to impinge the phosphorous layer, thereby exciting the phosphorous layer and emitting light therefrom.

The electron emission layer is composed of carbon nanotubes. Since carbon nanotubes, discovered by Iijima in 1991 (Nature, 354, 56 (1991)), comprise very good electronic properties that can be used to build a variety of devices. The carbon nanotubes also have a very large aspect ratio, mostly larger than 500, and a very high rigidity of Young moduli larger than 1000 GPn. In addition, the tips or defects of the carbon nanotubes are of atomic scale. The properties of carbon nanotubes described above are considered ideal for building electron field emitter, such as an electron emission source of a cathode structure of a field emission display. Since the carbon nanotubes comprise the physical properties described above, a variety of manufacturing process can be developed, e.g. screen printing, or thin film processing.

However, the art of manufacturing the cathode structure employs carbon nanotubes as an electron emission material, which is fabricated on the cathode conducting layer. The manufacturing process can be chemical vapor deposition process, or any kind of process that can pattern the photosensitive carbon nanotube solution on any pixel of the cathode conducting layer. Moreover, the cathode structure can also be manufactured by coating the carbon nanotube solution incorporating with a mask. However, there are still limitations of the manufacturing cost and the cubic structure for fabricating the carbon nanotubes on each pixel of the cathode electrode structure, according to the electron emission source structure of the triode field emission display described above. In particular, the homogeneity of large size electron emission source is even harder to achieve.

Recently, a so-called electrophoresis deposition (EPD) technology has be developed and disclosed in the United States Patent Publication No. US2003/0102222A1, entitled “Deposition Method for Nanostructure Materials”. In this patent publication, the carbon nanotubes are formulated into alcoholic suspension solution. On the other hand, ionic salts of magnesium, lanthanum, yttrium, aluminum act as a charger to prepare electrophoresis solution. The cathode structure to be deposited is connected with one electrode of the electrophoresis solution. By providing a DC or AC voltage, an electric field is formed in the solution. The chargers in the solution are then dissolved into ions, so as to adhere onto the powder of carbon nanotubes. For this reason, the electric field forms an electrophoresis force to assist the carbon nanotubes depositing onto a certain electrode. In this manner, the carbon nanotubes are deposited on a patterned electrode. By using the so-called electrophoresis technology described above, the carbon nanotubes are easily deposited onto an electrode and can easily circumvent the limitations of the cathode structure of the triode field emission display. Therefore, this method is widely used in the application of cathode plate fabrication.

Although the electrophoresis deposition method has been widely adopted, part of the mechanism therein requires improvements. First of all, in the electrophoresis mechanism, one can provide a DC or AC voltage to the solution to form an electric field, thereby depositing the powder particles on the electrode plate due to the electrophoresis force. However, for carbon nanotube powder that has very large aspect ratio, the nanotubes are easily deposited on certain areas or structures, such as the interface of air and fluid surface, or the peripheries of each patterned region adjacent the protection layer. In this manner, inhomogeneous deposition is easily formed, thereby rendering an inhomogeneous thickness of the electron emission source layer and an inhomogeneous electron beam production.

In addition, since the carbon nanotubes comprise very good distribution properties in the alcoholic solution, the conventional electrophoresis deposition method selects alcoholic solution as the solvent when fabricating the electron emission source layer. However, the use of alcoholic organic solution will induce cost and environmental problems when mass producing large size displays in the future. Nevertheless, the use of low-cost water solution requires breakthroughs in two aspects. First, the electrophoresis process induces the electrolysis of water, which produces hydrogen and oxygen gases, thereby affecting the deposition of carbon nanotubes. Second, the distribution property of carbon nanotubes in the water solution is not good enough, which requires further developments.

Moreover, the AC voltage mode applicable in the alcoholic solution in the conventional method provides only a possible deposition method. No significant effect has been shown yet.

### BRIEF SUMMARY OF THE INVENTION

The present invention is to provide a method to overcome the drawbacks in the conventional arts described above. In the present invention, a method suitable for use in the water solution of the electrophoresis carbon nanotubes is developed. The method provides some proper DC pulse electric field and a certain charger to the water solution of electrophoresis. The carbon nanotubes can be formulated into water solution and be deposited on the cathode structure. Note that the carbon nanotube powder is manufactured from arch discharge. Due to the limitation in the manufacturing process, the carbon nanotube powder is easily condensed into carbon nanotube bundles, which requires the use of ultrasonic waves to break them apart in the water solution. In addition, a dispersant is required to maintain the distribution property. However, adding dispersant to the water solution of electrophoresis will induce electro-chemical reactions. Therefore, some proper chargers are used to produce the ionic dispersion effect after the chargers are electrolyte. This can obtain a better distribution property for the water or alcoholic electrophoresis solution of the carbon nanotube powder, where no dispersant is required.

In order to achieve the above and other objectives, the method of the present invention for enhancing the homogeneity of carbon nanotube electron emission source, which is manufactured using electrophoresis deposition, includes the following steps. First, a semi-manufactured cathode structure is prepared. Then, the cathode structure and the metallic plate are connected to the electrophoresis electrodes.

After that, the side of the cathode structure to be electrophoresis deposited is kept a fixed distance in parallel with the metallic plate. Then, the electrophoresis deposition is performed to the semi-manufactured cathode structure by placing the combination into the solution of the electrophoresis tank. Later, an electric field is formed from a direct current pulse voltage of a power supply. In this manner, the to carbon nanotubes are deposited on the cathode electrode to form the electron emission source.

After the deposition process of the cathode structure is completed, the combination is baked with a low temperature so as to remove the residual water solution on the cathode structure. Meanwhile, the indium chloride charger and the electrolyte hydroxide ions react to form indium hydroxide. Next, a sintering process is performed for re-oxidating the indium hydroxide on the cathode electrode layer back to indium oxide. Consequently, the electron conductivity of the carbon nanotubes and the cathode electron layer is enhanced.

### BRIEF DESCRIPTION OF THE DRAWINGS

FIG. 1(a) to FIG. 1(g) illustrates a process for manufacturing a semi-manufactured cathode structure, in accordance with the present invention.

FIG. 2 illustrates a process for manufacturing the electron emission source, in accordance with the present invention.

FIG. 3 illustrates the connection of cathode structure and metallic plate, in accordance with the present invention.

FIG. 4 illustrates a electrophoresis deposition method performed after the cathode structure and the metallic plate is connected.

FIG. 5 illustrates a process for manufacturing carbon nanotubes by means of arch discharge, in accordance with the present invention.

### DETAILED DESCRIPTION OF THE INVENTION

In order to better understanding the features and technical contents of the present invention, the present invention is hereinafter described in detail by incorporating with the accompanying drawings. However, the accompanying drawings are only for the convenience of illustration and description, no limitation is intended thereto.

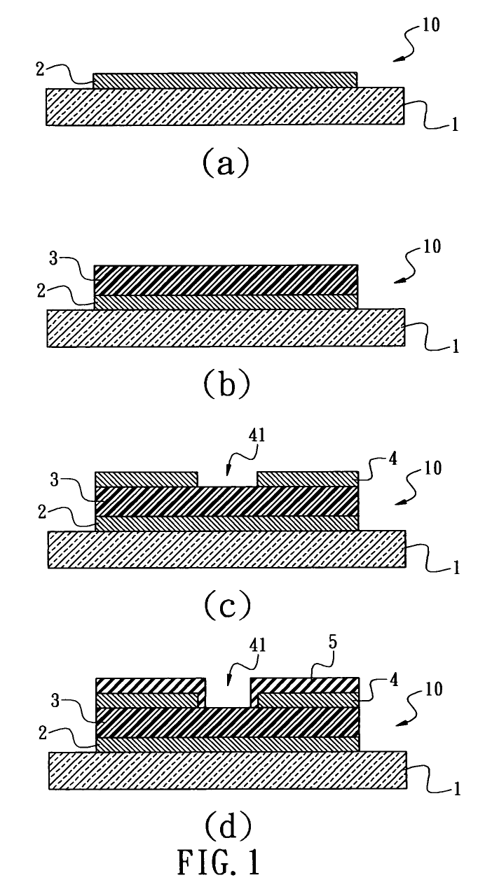

Referring to FIG. 1(a) to FIG. 1(g), a process for manufacturing a semi-manufactured cathode structure, in accordance with the present invention, is illustrated. As shown, the method of the present invention for enhancing the homogeneity of carbon nanotube electron emission source manufactured by means of electrophoresis deposition employs certain electrophoresis condition of electrophoresis carbon nanotube water solution to enhance distribution property of carbon nanotubes in the electrophoresis water solution during the arch discharge process, and to improve the homogeneity of electrophoresis in the cathode structure, thereby developing a better electrophoresis deposition method.

First, a cathode electrode layer 2 is formed on the surface of a glass substrate 1. A dielectric layer 3 is formed on the surface of the cathode electrode layer 2. Later, a gate electrode layer 4 is formed on the surface of the dielectric layer 3, and then forming a sagged region 41 thereon by lithography technology to expose the dielectric layer 3. Next, a protection layer 5 is formed on the surface of the gate electrode layer 41. A sagged region 31 is formed on the surface of the dielectric layer 3 exposing the cathode electrode layer 2. The protection layer 5 is then peeled off, and another protection layer 6 is coated covering the dielectric layer 3 and the gate electrode layer. Thus, a semi-manufactured cathode structure is completed.

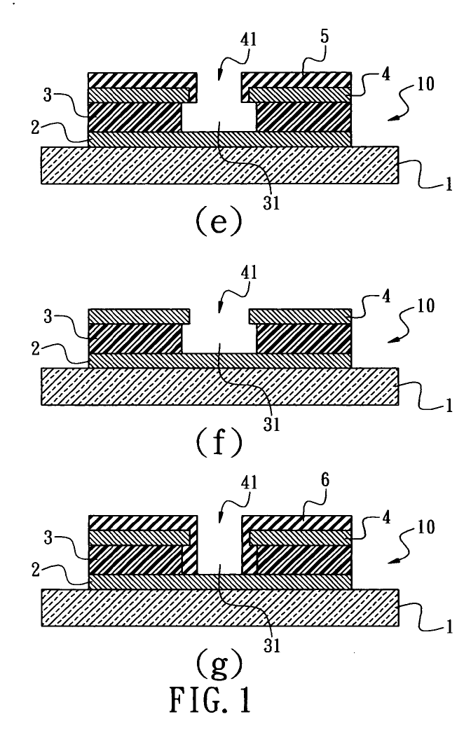

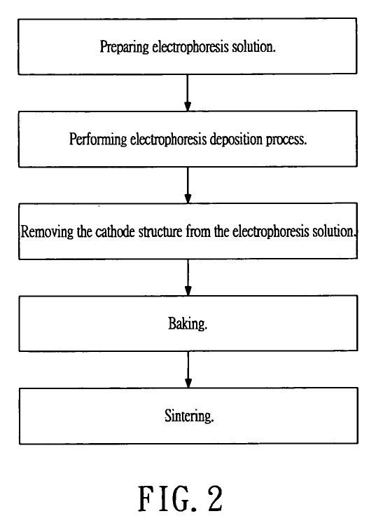

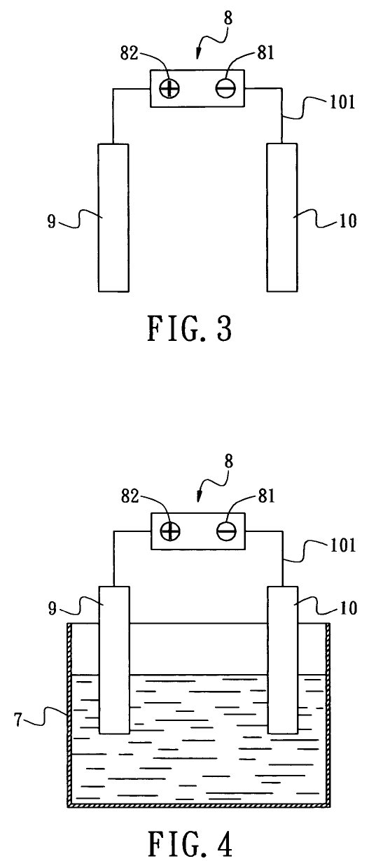

Referring to FIG. 2 to FIG. 4, the process for manufacturing the electron emission source, the connection of cathode structure and metallic plate, and the electrophoresis deposition method performed after the cathode structure and the metallic plate is connected, are respectively illustrated. As shown, after the completion of the semi-manufactured cathode structure mentioned above, the deposition process for manufacturing the carbon nanotube electron emission source of the cathode structure is performed.

First, the electrophoresis solution is prepared by taking pure water as a solvent. The electron emission source material of the electrophoresis employs multi-wall carbon nanotubes made from arch discharge. The average length and diameter of the carbon tubes are below 5 μm and 100 nm, respectively. The weight concentration of the carbon nanotubes is approximately 0.1%˜0.005% (preferably 0.02%). In addition, a charger of weight concentration of approximately 0.1%˜0.005% (preferably 0.01%) is added to the solution. The charger can be any metallic salt oxide that induces conductivity of the electrophoresis, such as indium chloride, indium nitrate, or any other salt such as tin. The prepared solution is then poured into the electrophoresis tank 7.

After the electrophoresis solution is prepared, one can perform the electrophoresis deposition process. The cathode layer 2 of the field emission cathode structure 10 is connected to the cathode electrode 81 of the electrophoresis electrode 8 via the cathode conducting wire 101. The anode electrode 82 of the electrophoresis electrode 8 is connected to the metallic plate 9. The metallic plate 9 described above can be of a platinum or titanium plate, or a screen plate.

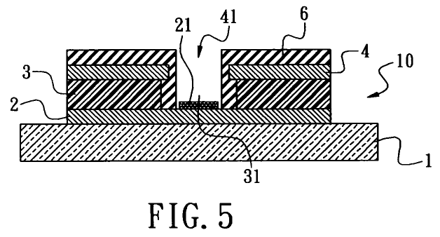

After the cathode structure 10 and the metallic plate 9 are combined, one side of the cathode structure 10 to be electrophoresis deposited is kept parallel to the metallic plate 9 with a fixed distance, and then disposed into the electrophoresis tank 7. A DC pulse voltage from a power supply is provided to the cathode electrode to form an electric field. The intensity of the electric field can be 0.5˜10 V/cm (preferably 2 V/cm), and the pulse frequency is 300 Hz. The carbon nanotubes are then electrophoresis deposited on the cathode electrode to form the electron emission source 21, as shown in FIG. 5.

After completing the above deposition process, the cathode structure moved to an oven and baked under a low temperature of 80° C. to remove the residual water solution on the cathode structure 10. Now, the charger indium chloride and the electrolyte hydroxyl forms indium hydroxide. A sintering process at a temperature of 400° C. is performed to burn off the protection layer 6. The indium hydroxide on the cathode electrode layer 2 is further oxidated to form indium oxide. Since indium oxide is conductive and is remained on the surface of the electron emission source 21 in addition to the deposited carbon nanotubes after the cathode electrode 2 is manufactured, it replaces the conventional magnesium salt charger that provides only the electrophoresis force, and enhances the electronic conduction of the carbon nanotubes and the cathode electrode layer.

Further, since the present invention employs the electrophoresis deposition method to form carbon nanotubes electron emission source layer, the carbon nanotubes are easily adhered parallel to the surface of the cathode electrode. Since the voltage provided is a DC pulse voltage, which can overcome the electrophoresis deposition effect on the surface of plate, thereby enhancing the deposition homogeneity of carbon nanotubes. In addition, the electrophoresis deposition method can prevent the production of bubbles of the electrolyte solution on the surface of electrodes, thereby affecting the adhesion of carbon nanotubes and the deposition homogeneity. By employing the method of the present invention, a homogeneous carbon nanotubes layer is easily formed. The average thickness can be controlled under 2 μm, while the carbon nanotubes and the salt of indium oxide are deposited together after sintering to form good adhesion effect, without dissemination.

Even further, the carbon nanotube electrophoresis solution comprises better distribution properties than that of the conventional magnesium chloride charger. By studying the distribution properties of the conventional charger, one can find that more than 15% of an average unit area of 250 μm² contains 10 μm carbon nanotube clusters. After changing the charger into indium chloride, the 10 μm carbon nanotube clusters can be controlled under 5%.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

What is claimed is:

1. A method for enhancing the homogeneity of carbon nanotube electron emission source manufactured using electrophoresis deposition, comprising the steps of:
preparing a semi-manufactured cathode structure;
performing electrophoresis deposition to the semi-manufactured cathode structure by connecting the cathode structure and the metallic plate to the electrophoresis electrodes;
after the metallic plate and the cathode structure are combined, one side of the cathode structure to be electrophoresis deposited being kept parallel to the metallic plate with a fixed distance, and placing the combination into the solution of the electrophoresis tank, forming a electric field by providing a direct current pulse voltage from a power supply, whereby the carbon nanotubes are deposited on the cathode electrode to form the electron emission source; and
after the deposition process of the cathode structure is completed, baking the combination with a low temperature so as to remove the residual water solution on the cathode structure, meanwhile, the indium chloride charger and the electrolyte hydroxide ions forming indium hydroxide, next performing the sintering process for re-oxidating the indium hydroxide on the cathode electrode layer back to indium oxide, thereby enhancing the electron conductivity of the carbon nanotubes and the cathode electron layer.

2. The method as recited in claim 1, wherein the method for manufacturing the semi-manufactured cathode structure comprising:
forming a cathode electrode layer on a glass substrate, forming a dielectric layer on the cathode electrode layer, forming a gate layer on the dielectric layer, and forming a sagged region on the gate layer by means of lithography technology to expose the cathode electrode layer;
forming a protection layer on the surface of the gate layer, etching the dielectric layer to form a sagged region exposing the cathode electrode, and performing peeling operation to the protection layer; and
forming another protection layer to cover the dielectric layer and the gate layer, thereby completing the manufacturing process of the semi-manufactured cathode structure.

3. The method as recited in claim 1, wherein the cathode electrode layer of the cathode structure is connected to the cathode of electrophoresis electrode, while the anode of the electrophoresis is connected to the metallic plate.

4. The method as recited in claim 1, wherein the metallic plate is made of platinum or titanium plate, or a screen plate.

5. The method of claim 1 wherein the intensity of electric field is approximately 0.5˜10 V/cm, and the pulse frequency is 300 Hz.

6. The method as recited in claim 5, wherein the intensity of electric field is preferably 2 V/cm.

7. The method as recited in claim 1, wherein the carbon nanotubes made from arch discharge are multi-wall carbon nanotubes comprising an average length of below 5 μm, and an average diameter below 100 nm.

8. The method as recited in claim 1, wherein the solution contained in the electrophoresis tank comprises pure water, carbon nanotube powder, and charger.

9. The method as recited in claim 8, wherein the weighted concentration of the added carbon nanotube powder is approximately 0.1%˜0.005%.

10. The method as recited in claim 9, wherein the weighted concentration of the added carbon nanotube powder is preferably 0.02%.

11. The method as recited in claim 8, wherein the weighted concentration of the added charger is approximately 0.1%˜0.005%.

12. The method as recited in claim 11, wherein the weighted concentration of the added charger is preferably 0.01%.

13. The method as recited in claim 11, wherein the charger is selected from any conductive metallic salt oxide after the electrophoresis process, such as indium chloride, indium nitride, and any other salt such as tin.

14. The method as recited in claim 1, wherein the baking temperature is approximately 80° C.

15. The method as recited in claim 1, wherein the sintering temperature is approximately 400° C.

16. The method as recited in claim 1, wherein the indium oxide is conductive, whereby the conductive indium oxide deposited on the cathode electrode layer can enhance the electron conductivity between the carbon nanotubes and the cathode electrode layer.

17. The method as recited in claim 1, wherein the electrophoresis deposited carbon nanotubes of the electron emission source layer are easily horizontally adhered to the surface of the cathode electrode due to the direct current pulse voltage applied thereto, whereby the deposition homogeneity of carbon nanotubes is improved, and the bubbles generated on the electrode surface from the electrolysis solution is reduced, and whereby a homogeneous carbon nanotube layer of average thickness below 2 μm is easily formed by means of the electrophoresis deposition technology, while the sintered carbon nanotubes and the chargers are deposited together to form a good adhesion effect.

18. The method as recited in claim 1, wherein the electrophoresis solution of carbon nanotubes comprises good distribution properties that can control the carbon nanotube clusters of 10 μm being below 5% in an average unit area of 250 μm², while the conventional chargers controls the carbon nanotube clusters of 10 μm being above 15%.
